(19) United States
(12) Patent Application Publication
(10) Pub. No.: US 2011/0300311 A1
(43) Pub. Date: Dec. 8, 2011

(54) PRODUCTION METHOD OF ELECTRODE AND DISCHARGE SURFACE TREATMENT THEREWITH

(75) Inventors: Mitsutoshi Watanabe, Tokyo (JP); Hiroki Yoshizawa, Tokyo (JP); Hiroyuki Ochiai, Tokyo (JP); Kyouhei Nomura, Tokyo (JP); Yukihiro Shimoda, Tokyo (JP)

(73) Assignee: IHI Corporation, Tokyo (JP)

(21) Appl. No.: 13/201,775

(22) PCT Filed: Feb. 15, 2010
(86) PCT No.: PCT/JP10/52191

§ 371 Date: Aug. 16, 2011

(30) Foreign Application Priority Data
Feb. 18, 2009 (JP) 2009-035205

(51) Int. Cl. B05D 1/04; B32B 9/04; B22F 7/02

(52) U.S. Cl. 427/580; 419/6; 428/411.1

(57) ABSTRACT

A surface treatment method of a subject body is comprised steps of: packing and pressurizing powder including an electrically conductive material in a mold so as to obtain a plurality of compressed powder bodies; joining the plurality of compressed powder bodies together by arranging the plurality of compressed powder bodies to be mutually in close contact and applying isostatic pressure on the arranged compressed powder bodies; sintering the joined compressed powder bodies so as to obtain a sintered body; and carrying out a discharge surface treatment by bringing the sintered body close to a subject body and generating electric discharge.

### TECHNICAL FIELD

The present invention relates to an electrode for utilizing electric discharge to form a coating or a deposition on a subject, and a method for forming a coating or a deposition therewith.

### BACKGROUND ART

To bring a non-consumable electrode close to a subject body in oil or in the air and generate electric discharge therebetween, the subject body can be machined. This art is in general referred to as electric spark machining, and is known to enable precise machining and formation of complex shapes. Under certain conditions, such as those where a consumable electrode such as a compressed powder body is used instead of a non-consumable electrode, or any, consumption of the electrode preferentially occurs instead of machining the subject body. A material constituting the electrode or its reaction result at this time covers an area on the subject body opposed to the electrode, thereby enabling surface treatment of the subject body. A related art is disclosed in an International Publication WO 99/58744. In the publication, this art is referred to as “discharge surface treatment”.

### DISCLOSURE OF INVENTION

As being understood from the above description, the subject of a discharge surface treatment is essentially limited to an area opposed to the electrode. This property is one of advantages of the discharge surface treatment as it enables localized surface treatment. On the other hand, in a case where surface treatment should be carried out on a large area with uniformity, it could be a disadvantage.

The present invention has been achieved in view of the aforementioned problem and its purpose is to provide an art which enables large area surface treatment while it is based on discharge surface treatment.

According to a first aspect of the present invention, a production method of an electrode for a discharge surface treatment is comprised of steps of: packing and pressurizing powder including an electrically conductive material in a mold so as to obtain a plurality of compressed powder bodies; joining the plurality of compressed powder bodies together by arranging the plurality of compressed powder bodies to be mutually in close contact and applying isostatic pressure on the arranged compressed powder bodies; and sintering the joined compressed powder bodies so as to obtain a sintered body.

Preferably, the production method further includes a step of preliminary isostatic pressure, wherein isostatic pressure is applied to each compressed powder body individually. More preferably, in the production method, the isostatic pressure in the step of joining is identical to pressure in the step of packing and pressurizing, and a second isostatic pressure in the step of preliminary isostatic pressure is lower than the isostatic pressure in the step of joining.

According to a second aspect of the present invention, a surface treatment method of a subject body is comprised of steps of: packing and pressurizing powder including an electrically conductive material in a mold so as to obtain a plurality of compressed powder bodies; joining the plurality of compressed powder bodies together by arranging the plurality of compressed powder bodies to be mutually in close contact and applying isostatic pressure on the arranged compressed powder bodies; sintering the joined compressed powder bodies so as to obtain a sintered body; and carrying out a discharge surface treatment by bringing the sintered body close to a subject body and generating electric discharge.

Preferably, the surface treatment method further includes a step of preliminary isostatic pressure, wherein isostatic pressure is applied to each compressed powder body individually. More preferably, in the surface treatment method, the isostatic pressure in the step of joining is identical to pressure in the step of packing and pressurizing, and a second isostatic pressure in the step of preliminary isostatic pressure is lower than the isostatic pressure in the step of joining.

### BRIEF DESCRIPTION OF DRAWINGS

FIG. 1 is a drawing explaining a production method of an electrode in accordance with an embodiment of the present invention, which illustrates a step of obtaining a compressed powder body by pressurizing.

FIG. 2 is a drawing explaining a step in the production method in which isostatic pressure is applied to each compressed powder body individually.

FIG. 3 is a drawing explaining a step in the production method in which a plurality of compressed powder bodies is arranged and then joined together.

FIG. 4 is a perspective view illustrating an example of a plurality of compressed powder bodies arranged to be mutually in close contact.

FIG. 5 is a schematic drawing showing a step of sintering in the production method.

FIG. 6 is a schematic drawing showing a discharge surface treatment method in accordance with the present embodiment.

FIG. 7 is a schematic drawing showing a mode of the discharge surface treatment method, in which an electrode and a subject body are installed in an electric spark machine.

### BEST MODE FOR CARRYING OUT THE INVENTION

Throughout the present specification and the appended claims, the term “discharge surface treatment” is defined and used as an act of utilizing electric discharge in an electric spark machine to consume an electrode instead of machining a subject body, and adhering a material constituting the electrode, or a reaction product between the material constituting the electrode and a machining liquid or a machining gas, onto the subject body as a coating.

An embodiment of the present invention will be described hereinafter with reference to the appended drawings.

In the present embodiment, first a consumable electrode for a discharge surface treatment is produced.

As a material for the consumable electrode, electrically conductive powder is preferable. The electrically conductive powder may, as a whole, consist of any metal or any semiconductor substance, or alternatively a mixture of any metal or a semiconductor substance and the other substance such as a proper ceramic. Which to choose is determined in accordance with properties required for a coating to be formed on a subject body.

Preferably a binder is added to the powder and then appropriately mixed thereto. As examples of the binder, paraffin, carnauba wax, polypropylene, polyethylene, acrylic resin, methacrylic resin, and acetal resins can be exemplified, however, any substance which helps loose bonding among powder particles and does not leave undesirable residual substances after sintering may be applicable.

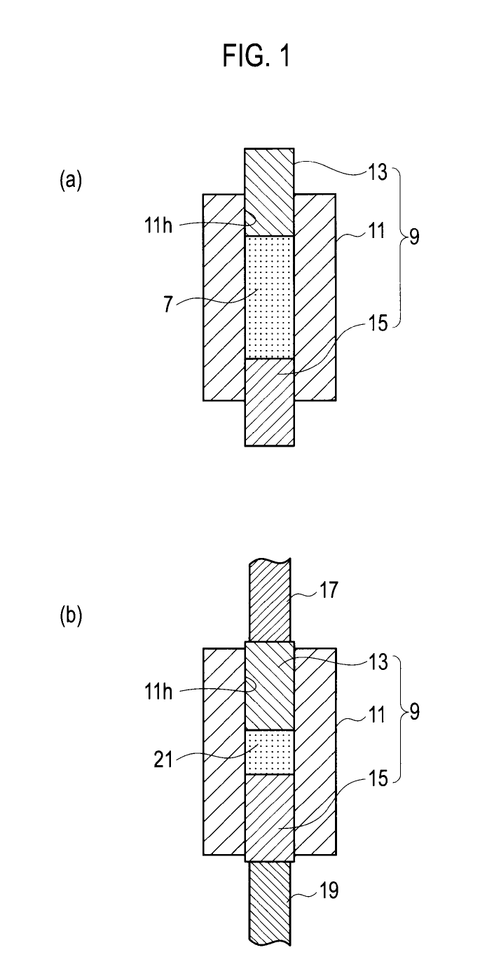

Powder 7 with the binder or such added thereto is, as shown in FIG. 1(a), packed in a mold 9. The mold 9 is comprised of a die 11 of a cylindrical shape for example, an upper punch 13 and a lower punch 15 both of which fit in an inner hole 11h of the die 11. The punches 13, 15 are slidable relative to the inner hole 11h and also establish a proper fit with the inner hole 11h so as to prevent leakage of the powder 7 when being pressurized.

The mold 9 with the powder 7 packed therein is charged in a proper press machine. The upper and lower punches 13, are pressurized by means of rams 17, 19 of the press machine so that the powder 7 packed in the mold 9 is pressurized. By this pressurizing, the powder 7 is as shown in FIG. 1(b) aggregated, thereby obtaining a compressed powder body 21 which does not readily collapse. The shape of the compressed powder body 21 can be properly regulated by the shape of the inner hole 11h and the amount of the powder 7, and is, for example, of a quadrangular prism shape with dimensions of 15 (D)×8 (W)×100 (L) mm³. Of course, other various shapes such as a hexagonal prism shape are possible. This step is reciprocally carried out and then a plurality of compressed powder bodies 21 is obtained.

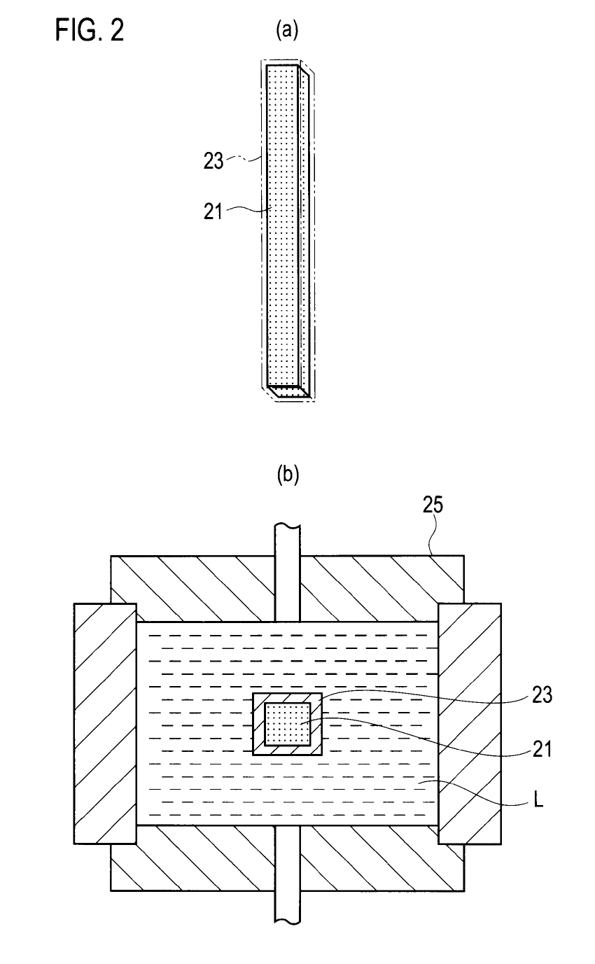

Preferably, preliminarily before subsequent steps, a process to apply isostatic pressure, such as cold isostatic press (CIP), is individually carried out on the compressed powder bodies 21. More specifically, each compressed powder body 21 is, as shown in FIG. 2(a), individually sealed in a thin rubber bag 23. Any proper elastic material instead of rubber may be utilized. The compressed powder body 21 along with the bag 23 in this state is, as shown in FIG. 2(b), immersed in liquid L in a pressure vessel 25 and then isostatically pressurized. This step improves uniformity of density of the compressed powder body 21 and accordingly improves uniformity of a final product.

Preferably the isostatic pressure in the preliminary isostatic pressure step is lower than a pressure in the step of pressurizing the powder 7. Such isostatic pressure is beneficial in prevention of deformation of the compressed powder body 21.

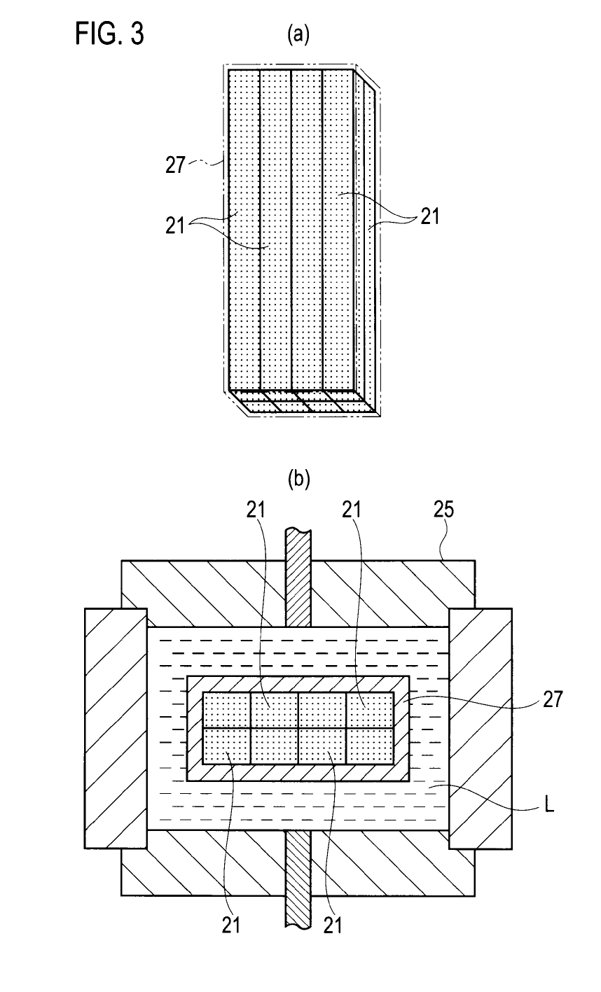

Next the compressed powder bodies 21 are arranged to be mutually in close contact. FIG. 3(a) illustrates one of such examples. A mode in which compressed powder bodies 21 having a common length are arranged in parallel may be applied, and also they may contain short compressed powder bodies 21 arranged in series. The number of the compressed powder bodies 21 can be increased or reduced as necessary. Preferably, they are brought into a state in which ends thereof are made flush with each other as shown in FIG. 3(a).

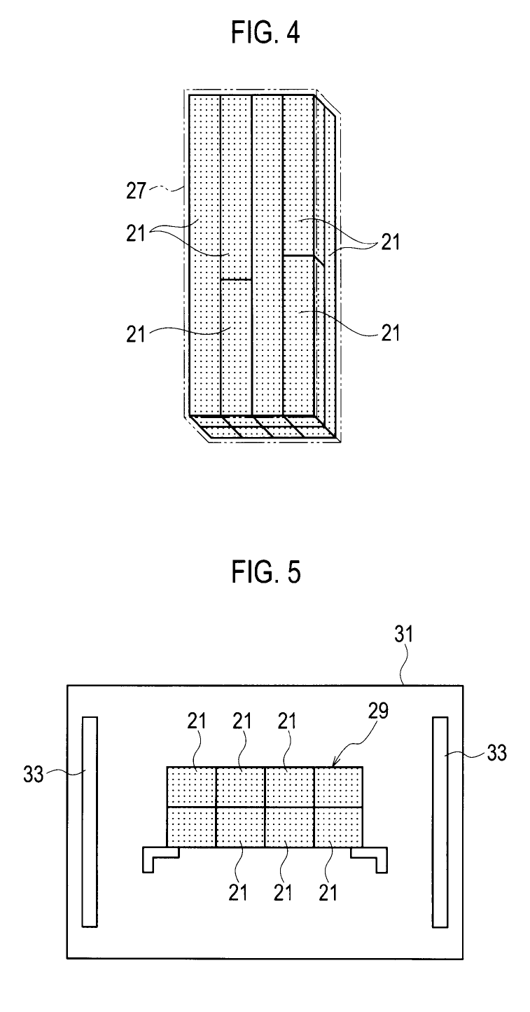

The plurality of compressed powder bodies 21 is sealed in a bag 27 of a rubber or such, and CIP is as shown in FIG. 3(b) carried out thereon. Alternatively, hot isostatic press (HIP) instead of CIP may be applied. In a case of applying HIP, a heating condition may be set up so that presintering in the compressed powder bodies 21 properly progresses. Alternatively it may be modified so that a sintering step as described later is simultaneously carried out in HIP. By applying isostatic pressure by means of the liquid L in the pressure vessel 25, the plurality of compressed powder bodies 21 is joined together to obtain a joined body 29 as shown in FIG. 4.

Preferably, the isostatic pressure applied on the plurality of compressed powder bodies 21 is identical to pressure in the step of pressurizing the powder V. Such isostatic pressure is beneficial in promoting joining while preventing deformation of the compressed powder bodies 21.

While the joined body 29 is composed of the plurality of compressed powder bodies 21, the compressed powder bodies 21 are mutually joined and thus the joined body 29 does not readily collapse. As keeping this state, the joined body 29 is as shown in FIG. 5 introduced into a heating furnace 31.

As the heating furnace 31, any furnace having ability of atmosphere control is preferable for the purpose of preventing oxidation. Preferably the atmosphere in the heating furnace 31 is set to be non-oxidative. By way of example of a non-oxidative atmosphere, a vacuum below 10⁻¹ Pa and inert atmospheres by inert gases such as nitrogen or argon can be exemplified.

The heating furnace 31 is further comprised of a proper heating means 33 such as a carbon heater. By heating the joined body 29 by means of the heating means 33, sintering progresses. In regard to the heating temperature, higher temperatures are advantageous in view of promotion of sintering, however, temperatures sufficiently lower than a melting point of the material constituting the power 7 are preferable in view of preventing a phenomena in that the electrode becomes hardly consumed as sintering overly progresses. Thus, as the heating temperature, 0.5-0.8 Tm can be exemplified where Tm (degrees C.) is a melting point of the material constituting the powder 7.

As sintering progresses, additives such as the binder contained in the compressed powder bodies 21 are evaporated and then disappear, and further firm bonds among the particles in the powder appear. Moreover also among the plurality of compressed powder bodies 21, firm bonds appear. The sintered body as a result becomes a single solid as a whole. To utilize it as an electrode for a discharge surface treatment, sintering should be stayed at a stage where openings among the particles do not disappear. According to the aforementioned process, in considerable cases, the openings among the particles do not appear without taking any particular measures, thereby giving a porous sintered body.

Meanwhile joining and sintering may be simultaneously carried out, as described already, by means of HIP, instead of independent execution of the step of sintering and the step of joining.

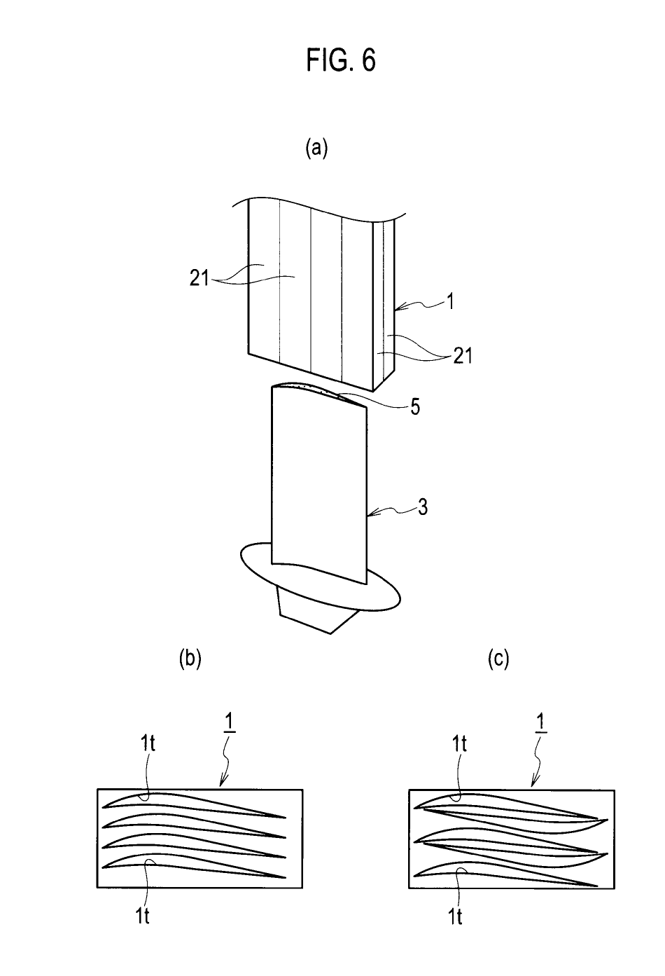

After finishing the sintering, the sintered body is properly cooled so as to prevent excessive thermal shock thereon. The sintered body is thereafter taken out of the heating furnace 31. The sintered body as shown in FIG. 6 can be utilized as an electrode 1 for a discharge surface treatment.

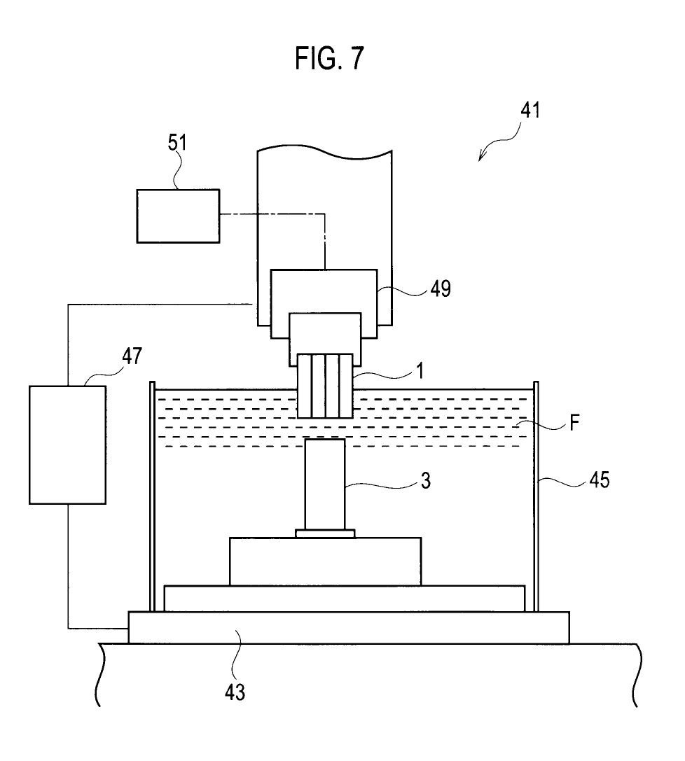

A discharge surface treatment with using the electrode formed of the sintered body as produced in a way as described above will be described with reference to FIGS. 6 and 7 hereinafter. While the discharge surface treatment will be applicable to various products, FIG. 6 illustrates an example in that a subject body 3 of the surface treatment is a rotor blade of a gas turbine engine and an area of the subject is a tip end of the rotor blade.

Referring to FIG. 7, an electric spark machine 41 is comprised of an electrically conductive bed 43, a machining bath 45 capable of pooling a machining liquid F, a power supply 47, and a head 49 to which the electrode is fixed. The head 49 is capable of going up and down by means of any proper means, and further the electric spark machine 41 may be comprised of a servomotor 51 for making the head go up and down. In the machining bath 45, a non-conductive machining liquid F such as oil is pooled, and a tip end of the electrode 1 and the subject body 3 are both immersed in the machining liquid F. Alternatively, in the air or any gas instead of the liquid F, the discharge surface treatment can be carried out. The subject body 3 is fixed on the bed 43 so as to allow current conduction therethrough. Both poles of the power supply 47 are respective electrically connected to the bed 43 and the head 49, thereby allowing current conduction from the power supply 47 to the electrode 1 and the subject body 3.

In the electric spark machine 41 as described above, the electrode 1 is brought close to a subject area of the subject body 3. Then electricity is supplied from the power supply 47 and discharge is thereby generated between the electrode 1 and the subject body 3. Preferably the supplied electricity is made intermittent so that the discharge is generated in a pulsed manner. As the electrode 1 is porous as described above, it undergoes consumption preferentially relative to the subject body 3, thereby the material constituting the electrode 1, as a coating, adheres to the subject area on the subject body 3. Alternatively, by properly selecting the material constituting the electrode 1 and the machining liquid F, its reaction product may be the coating 5. Part of energy of the discharge is thrown into the subject area of the subject body 3 so as to cause local fusion and therefore bonding between the coating 5 and the subject body 3 is firm. Further, as a part in the subject body 3 in which the energy of the discharge is thrown is localized and superficial, the subject body 3 hardly experiences thermal damage and deformation.

As the electrode 1 is consumed, a depression 1t as shown in FIG. 6(b) develops on the lower end of the electrode 1. The depression 1t has a shape corresponding to the subject area of the subject body 3. When such consumption grows up to a considerable level, it is preferable to slightly move the electrode 1 or the subject body 3 so as to have a fresh surface of the electrode 1 opposed to the subject area. FIG. 6(b) illustrates a state after repeating such processes several times. Alternatively, instead of slightly moving the electrode 1 or the subject body 3, it may be preferable to flip it horizontally. FIG. 6(c) illustrates such an example.

According to the present embodiment, as plural compressed powder bodies 21 are individually formed, each compressed powder 21 is accurate in shape and is further uniform in density. As the electrode 1 is formed by joining and sintering them, these properties are reflected in the resultant product, thereby the electrode 1 has high accuracy in shape and high uniformity. In contrast, in accordance with studies by the present inventors, when a relatively large-sized electrode is not formed by the present method but formed directly by molding and sintering, it results in non-uniformity in density from its periphery toward its center generates and often deformation by shrinkage around its center. Such a sintered body is not suitable for an electrode for a discharge surface treatment in view of its shape and non-uniformity. As compared with such a situation, the present embodiment is prominently advantageous in accuracy in shape and uniformity.

According to the present embodiment, an electrode with accuracy in shape and uniformity can be constituted even though it is large-sized. Scalable expansion of its dimensions is enabled while accuracy in shape and uniformity are retained at high levels. The present embodiment enables uniform surface treatment on a large area. As it is based on a discharge surface treatment, one can still enjoy an advantage in that a surface-treated area is limited within a area opposed to the electrode.

Although the invention has been described above by reference to certain embodiments of the invention, the invention is not limited to the embodiments described above. Modifications and variations of the embodiments described above will occur to those skilled in the art, in light of the above teachings.

### INDUSTRIAL APPLICABILITY

An art which enables large area surface treatment is provided while it is based on a discharge surface treatment.

1. A production method of an electrode for a discharge surface treatment comprising the steps of:
packing and pressurizing powder including an electrically conductive material in a mold so as to obtain a plurality of compressed powder bodies;
joining the plurality of compressed powder bodies together by arranging the plurality of compressed powder bodies to be mutually in close contact and applying isostatic pressure on the arranged compressed powder bodies; and
sintering the joined compressed powder bodies so as to obtain a sintered body.

2. The production method of claim 1, further comprising the step of preliminary isostatic pressure, wherein isostatic pressure is applied to each compressed powder body individually.

3. The production method of claim 2, wherein the isostatic pressure in the step of joining is identical to pressure in the step of packing and pressurizing, and a second isostatic pressure in the step of preliminary isostatic pressure is lower than the isostatic pressure in the step of joining.

4. An electrode for a discharge surface treatment produced by the production method of claim 1.

5. A surface treatment method of a subject body, comprising the steps of:
packing and pressurizing powder including an electrically conductive material in a mold so as to obtain a plurality of compressed powder bodies;
joining the plurality of compressed powder bodies together by arranging the plurality of compressed powder bodies to be mutually in close contact and applying isostatic pressure on the arranged compressed powder bodies;
sintering the joined compressed powder bodies so as to obtain a sintered body; and
carrying out a discharge surface treatment by bringing the sintered body close to a subject body and generating electric discharge.

6. The surface treatment method of claim 5, further comprising the step of preliminary isostatic pressure, wherein isostatic pressure is applied to each compressed powder body individually.

7. The surface treatment method of claim 6, wherein the isostatic pressure in the step of joining is identical to pressure in the step of packing and pressurizing, and a second isostatic pressure in the step of preliminary isostatic pressure is lower than the isostatic pressure in the step of joining.
